(19) United States
(12) Patent Application Publication
(10) Pub. No.: US 2016/0086558 A1
(43) Pub. Date: Mar. 24, 2016

(54) DISPLAY PANEL AND DRIVING METHOD THEREOF

(71) Applicant: SHENZHEN CHINA STAR OPTOELECTRONICS TECHNOLOGY CO., LTD., Shenzhen, Guangdong (CN)

(72) Inventor: Juncheng Xiao, Shenzhen (CN)

(73) Assignee: SHENZHEN CHINA STAR OPTOELECTRONICS TECHNOLOGY CO.,LTD., Shenzhen,Guangdong (CN)

(21) Appl. No.: 14/405,186

(22) PCT Filed: Oct. 16, 2014
(86) PCT No.: PCT/CN2014/088707

§ 371 Date: Dec. 3, 2014

(30) Foreign Application Priority Data
Sep. 19, 2014 (CN) 201410483898.2

(51) Int. Cl. G09G 3/36

(52) U.S. Cl. CPC G09G 3/3648; G09G 3/3607; G09G 2310/08; G09G 2310/021; G09G 2310/0286

(57) ABSTRACT

A display panel and a driving method thereof are disclosed. A thin film transistor array substrate of the display panel comprises pixel elements, scan lines, data lines, and a driving circuit; a first scan line and a second scan line are both connected to the pixel elements; the data lines are connected the pixel elements of a pixel column; the driving circuit operates to produce a second driving signal in accordance with a first driving signal; the pixel elements connected to the first scan line and the second line are staggered. Thus, uneven charging can be avoided.

### FIELD OF THE INVENTION

The present invention relates to a technical field of displays, and more particularly to a display panel and a driving method thereof.

### BACKGROUND OF THE INVENTION

In a traditional GOA (Gate driver On Array) technical solution, a scan driving circuit is generally formed on a thin film transistor array substrate through the existing manufacturing process of the thin film transistor array substrate, in order to implement progressive scanning on the thin film transistor array substrate.

In the process of implementing the tradition GOA manufacturing process, the inventor found at least the following problems with the prior art:

In the process of using a scan driving circuit to control TFT switches to be open in order to control the charging of pixel elements, for different pixel elements, uneven charging usually occurs charging due to the electronic potential difference of the pre-charge. This situation will result in a significant difference in the brightness and darkness of the overall screen, thereby reducing the display quality of a display panel.

As a result, it is necessary to provide a display panel to solve the problems existing in the conventional technologies, as described above.

### SUMMARY OF THE INVENTION

A primary object of the present invention is to provide a display panel and driving method thereof, which is able to make pixel elements of different pixel rows charging equally.

To solve the above problems, the technical solution of the present invention is as follows:

A display panel is provided, and the display panel comprises: a color filter substrate; a liquid crystal layer; and a thin film transistor array substrate, the thin film transistor array substrate comprising: a pixel element array comprising at least two pixel rows and at least one pixel column combination, the pixel column combination comprising two pixel columns, the pixel row and the pixel column both being composed of pixel elements, wherein the pixel row comprises at least two of the pixel elements, and the pixel column comprises at least two of the pixel elements; a scan line array comprising at least two scan line combinations, at least two of the scan line combinations arranged in an array along a first direction, the scan line combination comprising a first scan line and a second scan line, the first scan line and the second scan line both connected to the pixel element of the pixel row; a data line array comprising at least two data lines, at least two of the data lines arranged in an array along a second direction, the data line connected to each of the pixel elements of the two pixel columns of the pixel column combination, wherein the first direction is perpendicular to the second direction; and a driving circuit, the driving circuit connected to the scan line and the data line, the driving circuit operative to receive a first driving signal, to produce a second driving signal in accordance with the first driving signal, and to transmit the second driving signal to the pixel element array through the scan line array; wherein the pixel elements connected to the first scan line and the pixel elements connected to the second scan line stagger in the pixel row; the driving circuit comprising: a signal input port operative to receive the first driving signal; a signal output port operative to output the second driving signal; and a shift register combination, the shift register combination connected to the signal input port and the signal output port, and the shift register combination operative to produce the second driving signal in accordance with the first driving signal; the second driving signal comprising a first scanning signal and a second scanning signal; the signal output port comprising: at least a first signal output end operative to output the first scanning signal; and at least a second signal output end operative to output the second scanning signal; the driving circuit further comprising: a power signal receiving end operative to receive a power signal; and a first start signal receiving end operative to receive a first start signal; the shift register combination comprising: at least a first shift register, the first shift register connected to the signal input port, the power signal receiving end, the first start signal receiving end, and the first signal output end; the first shift register operative to receive the first start signal, to produce the first scanning signal in accordance with the first driving signal at the first start signal triggering, and to produce a second start signal after producing the first scanning signal; and at least a second shift register, wherein the second shift register is connected to the signal input port, the power signal receiving end, and the first shift register; the second shift register operative to receive the second start signal, to produce the second scanning signal in accordance with the first driving signal at the second start signal triggering, to transmit the second scanning signal to the first shift register, and to produce a third start signal after producing the second scanning signal; wherein two of the neighboring pixel columns share the same data line; and, in objects connected to the pixel row, there is only one of the data lines.

In the above described display panel, the first driving signal comprises a first clock signal, a second clock signal, a third clock signal and a fourth clock signal; wherein the signal input port comprises: a first signal input end operative to receive the first clock signal; a second signal input end operative to receive the second clock signal; a third signal input end operative to receive the third clock signal; and a fourth signal input end operative to receive the fourth clock signal; the first shift register connected to any two of the first signal output end, the second signal output end, the third signal output end, and the fourth signal output end, the first shift register operative to produce the first scanning signal in accordance with any two of the first clock signal, the second clock signal, the third clock signal, and the fourth clock signal; and the second shift register connected to any two of the first signal output end, the second signal output end, the third signal output end, and the fourth signal output end, the second shift register operative to produce the second scanning signal in accordance with the first clock signal, the second clock signal, the third clock signal, and the fourth clock signal.

In the above descried display panel, the driving circuit further comprises: a first regulator combination connected to the shift register combination and the signal input port, the first regulator combination operative to regulate the first driving signal before the shift register combination producing the second driving signal, and to output the regulated first driving signal to the shift register combination; the shift register combination operative to produce the second driving signal in accordance with the regulated first driving signal.

In the above described display panel, the driving circuit further comprises: a second regulator combination connected to the shift register combination and the signal output port, the second regulator combination operative to regulate the second driving signal after the shift register combination producing the second driving signal, and to output the regulated second driving signal to the pixel element array through the scan line array.

A display panel is provided, and the display panel comprises: a color filter substrate; a liquid crystal layer; and a thin film transistor array substrate, the thin film transistor array substrate comprising: a pixel element array comprising at least two pixel rows and at least one pixel column combination, the pixel column combination comprising two pixel columns, the pixel row and the pixel column both being composed of pixel elements, wherein the pixel row comprises at least two of the pixel elements, and the pixel column comprises at least two of the pixel elements; a scan line array comprising at least two scan line combinations, at least two of the scan line combinations arranged in an array along a first direction, the scan line combination comprising a first scan line and a second scan line, the first scan line and the second scan line both connected to the pixel element of the pixel row; a data line array comprising at least two data lines, at least two of the data lines arranged in an array along a second direction, the data line connected to each of the pixel elements of the two pixel columns of the pixel column combination, wherein the first direction is perpendicular to the second direction; and a driving circuit the driving circuit connected to the scan line and the data line, the driving circuit operative to receive a first driving signal, to produce a second driving signal in accordance with the first driving signal, and to transmit the second driving signal to the pixel element array through the scan line array; wherein the pixel elements connected to the first scan line and the pixel elements connected to the second scan line stagger in the pixel row.

In the above described display panel, two of the neighboring pixel columns share the same data line; and, in objects connected to the pixel row, there is only one of the data lines.

In the above described display panel, the driving circuit comprises: a signal input port operative to receive the first driving signal; a signal output port operative to output the second driving signal; and a shift register combination, the shift register combination connected to the signal input port and the signal output port, and the shift register combination operative to produce the second driving signal in accordance with the first driving signal.

In the above described display panel, the second driving signal comprises a first scanning signal and a second scanning signal; wherein the signal output port comprises: at least a first signal output end operative to output the first scanning signal; and at least a second signal output end operative to output the second scanning signal; wherein the driving circuit further comprises: a power signal receiving end operative to receive a power signal; and a first start signal receiving end operative to receive a first start signal; wherein the shift register combination comprises: at least a first shift register, the first shift register connected to the signal input port, the power signal receiving end, the first start signal receiving end and the first signal output end; the first shift register operative to receive the first start signal, to produce the first scanning signal in accordance with the first driving signal at the first start signal triggering, and to produce a second start signal after producing the first scanning signal; and at least a second shift register, the second shift register connected to the signal input port, the power signal receiving end and the first shift register; the second shift register operative to receive the second start signal, to produce the second scanning signal in accordance with the first driving signal at the second start signal triggering, to transmit the second scanning signal to the first shift register, and to produce a third start signal after producing the second scanning signal.

In the above described display panel, the first driving signal comprises a first clock signal, a second clock signal, a third clock signal, and a fourth clock signal; wherein the signal input port comprises: a first signal input end operative to receive the first clock signal; a second signal input end operative to receive the second clock signal; a third signal input end operative to receive the third clock signal; and a fourth signal input end operative to receive the fourth clock signal; the first shift register connected to any two of the first signal output end, the second signal output end, the third signal output end and the fourth signal output end, the first shift register operative to produce the first scanning signal in accordance with any two of the first clock signal, the second clock signal, the third clock signal and the fourth clock signal; and the second shift register connected to any two of the first signal output end, the second signal output end, the third signal output end and the fourth signal output end, the second shift register operative to produce the second scanning signal in accordance with any two of the first clock signal, the second clock signal, the third clock signal, and the fourth clock signal.

In the above described display panel, each shift register of the shift register combination operates to produce scanning signals based on a second predetermined order; wherein the second predetermined order is: firstly producing scanning signals of odd number pixel rows successively by the odd number pixel rows corresponding to at least two of the shift registers, and then producing scanning signals of even number pixel rows successively by the even number pixel rows corresponding to at least two of the shift registers.

In the above described display panel, the driving circuit further comprises: a first regulator combination connected to the shift register combination and the signal input port, the first regulator combination operative to regulate the first driving signal before the shift register combination producing the second driving signal, and to output the regulated first driving signal to the shift register combination; the shift register combination further operative to produce the second driving signal in accordance with the regulated first driving signal.

In the above described display panel, wherein the first regulator combination comprises at least two first regulators, the first regulator being a first current regulating resistance; wherein the first current regulating resistance connects to the shift register combination and the signal input port.

In the above described display panel, the driving circuit further comprises: a second regulator combination connected to the shift register combination and the signal output port, the second regulator combination operative to regulate the second driving signal after the shift register combination producing the second driving signal, and to output the regulated second driving signal to the pixel element array through the scan line array.

In the above described display panel, the second regulator combination comprises at least two second regulators, the second regulator being a second current regulating resistance; wherein the second current regulating resistance connects to the shift register combination and the signal input port.

A driving method of a display panel comprises steps of: (A) receiving the first driving signal at a signal input port; (B) producing the second driving signal in accordance with the first driving signal by the shift register combination; and (C) outputting the second driving signal at a signal output port.

In the above described driving method, the second driving signal comprises a first scanning signal and a second scanning signal; the step (B) comprising steps of: (b1) receiving a first start signal by a first start signal receiving end of the driving circuit; (b2) using a first shift register of the shift register combination to receive the first start signal, producing the first scanning signal in accordance with the first driving signal at the first start signal triggering, and producing a second start signal after producing the first scanning signal; and (b3) using a second shift register of the shift register combination to receive the second start signal, producing the second scanning signal in accordance with the first driving signal at the second start signal triggering, transmitting the second scanning signal to the first shift register, and producing a third start signal after producing the second scanning signal.

In the above described driving method, the first driving signal comprises a first clock signal, a second clock signal, a third clock signal, and a fourth clock signal; the method further comprising steps of: receiving the first clock signal by a first signal input end of the signal input port; receiving the second clock signal by a second signal input end of the signal input port; receiving the third clock signal by a third signal input end of the signal input port; receiving the fourth clock signal by a fourth signal input end of the signal input port; producing the first scanning signal by the first shift register in accordance with any two of the first clock signal, the second clock signal, the third clock signal, and the fourth clock signal, wherein the first shift register is connected to any two of the first signal output end, the second signal output end, the third signal output end, and the fourth signal output end; and producing the second scanning signal by the second shift register in accordance with any two of the first clock signal, the second clock signal, the third clock signal, and the fourth clock signal, wherein the second shift register is connected to any two of the first signal output end, the second signal output end, the third signal output end, and the fourth signal output end.

In the above described driving method, the method further comprises a step of: producing scanning signal based on a second predetermined order by each shift register of the shift register combination; wherein the second predetermined order is: firstly producing scanning signals of odd number pixel rows successively by the odd number pixel rows corresponding to at least two of the shift registers, and then producing scanning signals of even number pixel rows successively by the even number pixel rows corresponding to at least two of the shift registers.

In the above described driving method, after the step (A) and before the step (B), the method further comprises a step of: (D) using a first regulator combination of the driving circuit to regulate the first driving signal before the shift register combination producing the second driving signal, and then outputting the regulated first driving signal to the shift register combination; wherein the step (B) is: producing the second driving signal in accordance with the regulated first driving signal by the shift register combination.

In the above described driving method, after the step (B) and before the step (C), the method further comprises a step of: (E) using a second regulator combination of the driving circuit to regulate the second driving signal after the shift register combination producing the second driving signal, and then to output the regulated second driving signal to the pixel element array through the scan line array.

In contrast to the prior art, the present invention enables equal charging for pixel elements of different pixel rows and avoids charging unevenly. This reduces abnormalities in the screen display, and ensures the overall display quality of the screen.

To allow the above description of the present invention to be more clear and comprehensive, there are preferred embodiments with the accompanying figures described in detail below.

### DESCRIPTION OF THE DRAWINGS

FIG. 1A is a schematic diagram of a display panel according to a first embodiment of the present invention.

FIG. 1B is a schematic diagram of the signal of FIG. 1A.

FIG. 2A is a schematic diagram of a display panel according to a second embodiment of the present invention.

FIG. 2B is a schematic diagram of the signal of FIG. 2A.

FIG. 3 is a schematic diagram of a driving circuit of the display panel according to the first embodiment of the present invention.

FIG. 4 is a schematic diagram of a driving circuit of the display panel according to the second embodiment of the present invention.

FIG. 5 is a schematic diagram of a driving circuit of the display panel according to a third embodiment of the present invention.

FIG. 6 is a schematic diagram of a driving circuit of the display panel according to a fourth embodiment of the present invention.

FIG. 7 is a flowchart of a driving method of the display panel according to the first embodiment of the present invention.

FIG. 8 is a flowchart of the steps of producing a second driving signal in accordance with a first driving signal by a shift register combination.

FIG. 9 is a flowchart of a driving method of the display panel according to the second embodiment of the present invention.

FIG. 10 is a flowchart of a driving method of the display panel according to the third embodiment of the present invention.

### DETAILED DESCRIPTION OF THE PREFERRED EMBODIMENTS

The word “embodiment” used in this specification means examples, demonstrations, or illustrations. In addition, the word “a” of this specification and the corresponding claims can be explained as “one or more”, unless it is designated or clearly guided to a singular form.

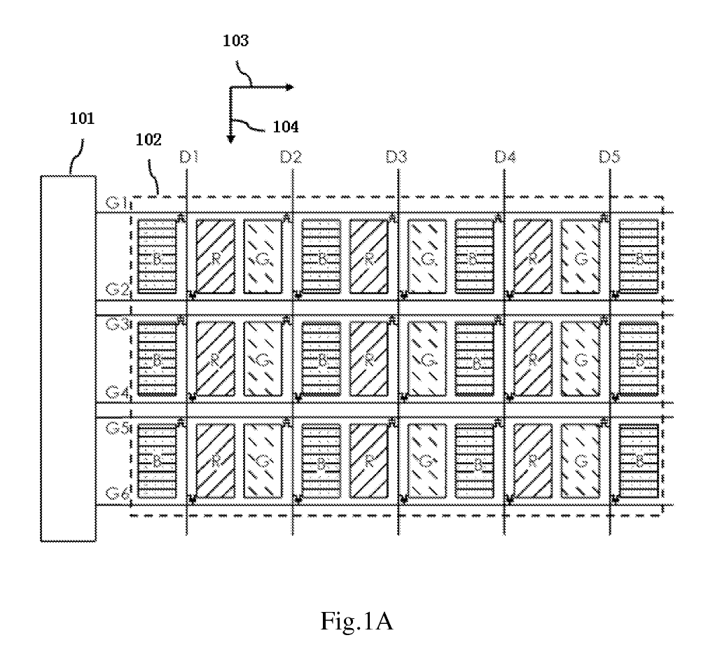

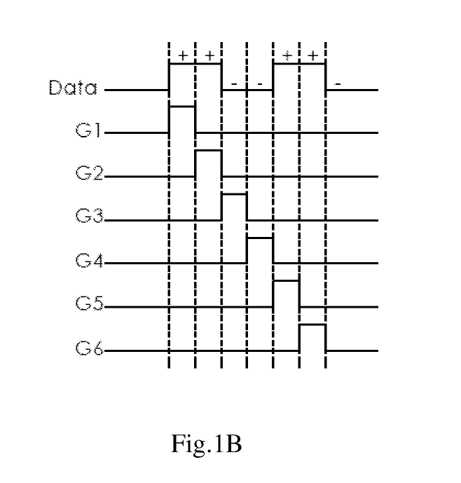

Referring to FIG. 1A and FIG. 1B, FIG. 1A is a schematic diagram of a display panel according to a first embodiment of the present invention. FIG. 1B is a schematic diagram of the signal of FIG. 1A.

A display panel according to a first embodiment of the present invention comprises a color filter (CF) substrate, a liquid crystal (LC) layer and a thin film transistor array (TFT array) substrate. The color filter substrate and the thin film transistor array substrate superimpose as one object. The liquid crystal layer is set up between the color filter substrate and the thin film transistor array substrate.

Wherein the TFT array substrate comprises a pixel element array 102, scan line arrays G1, G2, G3, G4, G5, and G6, data line arrays D1, D2, D3, D4, and D5, and a driving circuit 101. The driving circuit 101 is set up on the TFT array substrate. The driving circuit 101 is set up on the TFT array substrate. The driving circuit 101 is formed on the TFT array substrate in the manufacturing process of the TFT array substrate. The driving circuit 101 is operative to implement progressive scanning to the thin film transistor array substrate.

The pixel element array 102 comprises at least two pixel rows and at least one pixel column combination. The pixel column combination comprises two pixel columns. The pixel row and the pixel column are both composed by pixel elements, wherein the pixel row comprises at least two of the pixel elements, and the pixel column comprises at least two of the pixel elements.

The scan line arrays G1, G2, G3, G4, G5, and G6 comprise at least two scan line combinations. At least two of the scan line combinations arranged in an array along a first direction 104. The scan line combination comprises a first scan line and a second scan line, and the first scan line and the second scan line are both connected to the pixel element of the pixel row. The pixel elements connected to the first scan line and the pixel elements connected to the second scan line stagger in the pixel row.

The data line arrays D1, D2, D3, D4, and D5 comprise at least two data lines. At least two of the data lines are arranged in an array along a second direction 103. The data line is connected to each of the pixel elements of the two pixel columns of the pixel column combination, wherein the first direction is perpendicular to the second direction. In objects connected to the pixel row, there is only one of the data lines. Namely, there is only one data line connected to any one of the pixel columns.

The driving circuit 101 is connected to the scan line and the data line. The driving circuit 101 is operative to receive a first driving signal, and to produce a second driving signal in accordance with the first driving signal, and to transmit the second driving signal to the pixel element array 102 through the scan line arrays G1, G2, G3, G4, G5, and G6.

In the present embodiment, a first connection way and a second connection way are the same for any two of the neighboring pixel rows, wherein the first connection way is a connection way between the pixel element of one of the pixel rows and the scan line combination (the first scan line, the second scan line), and the second connection way is a connection way between the pixel element of the other pixel rows, the first scan line, and the second scan line.

In the present embodiment, the polarity of data signals “Data” of the data line arrays D1, D2, D3, D4, and D5 provided to the pixel element array 102 are positive, positive, negative, negative, positive, positive . . . and so on.

In the present embodiment, the driving of the gate end/the scan line becomes double through halving the driving of the source/the data line. This will reduce cost of the source driving chip without affecting the display quality.

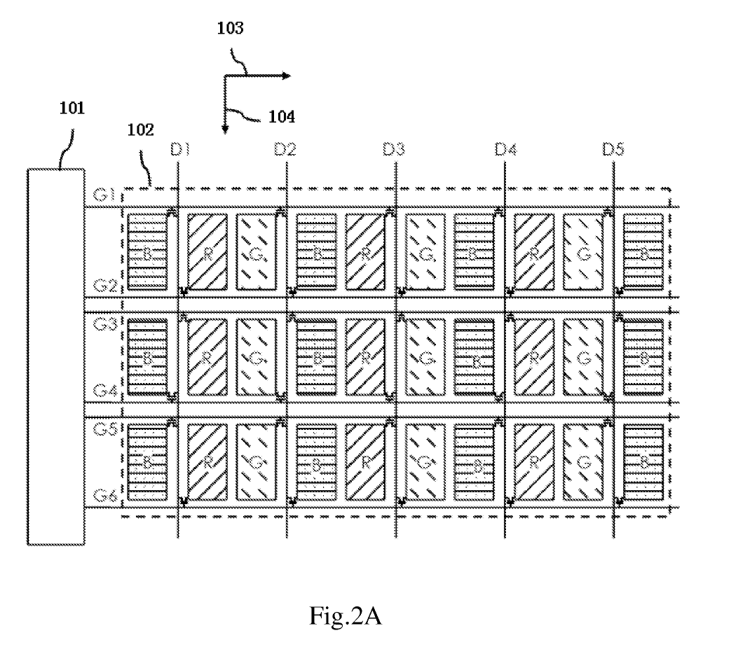

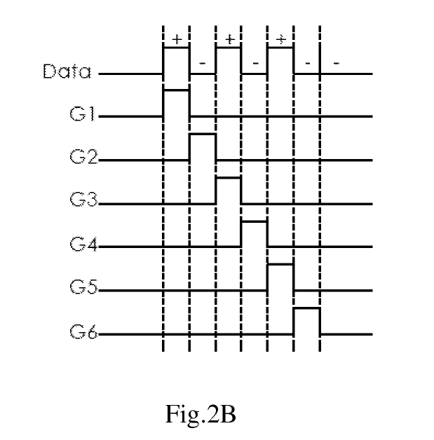

Referring to FIG. 2A and FIG. 2B, FIG. 2A is a schematic diagram of a display panel according to a second embodiment of the present invention. FIG. 2B is a schematic diagram of the signal of FIG. 2A.

The display panel of the second embodiment is similar to the display panel of the first embodiment, and the difference is as follows:

In the present embodiment, a first connection way and a second connection way are the same for any two of the neighboring pixel rows, wherein the first connection way is a connection way between the pixel element of one of the pixel rows and the scan line combination (the first scan line, the second scan line), and the second connection way is a connection way between the pixel element of the other pixel rows, the first scan line, and the second scan line.

In the present embodiment, the polarity of data signals “Data” of the data line arrays D1, D2, D3, D4, and D5 provided to the pixel element array 102 are positive, negative, positive, negative, positive, negative . . . and so on.

The technical solution of the present embodiment avoids uneven charging due to the electronic potential difference of the pre-charge, thus avoiding the brightness and darkness difference of the overall display screen due to the electronic potential difference by the charging of the different pixel rows.

Furthermore, the technical solution of the present invention further avoids the charging ratio of the different pixel rows having a big difference due to the overall charging ratio of the display panel being worse when the resistance-capacitance is great. Therefore, the display quality of the display panel is ensured.

The display panel of the third embodiment is similar to the display panel of the first embodiment or the second embodiment, and the difference is as follows:

The driving circuit 101 comprises a signal input port 302, a signal output port 303 and a shift register combination 301.

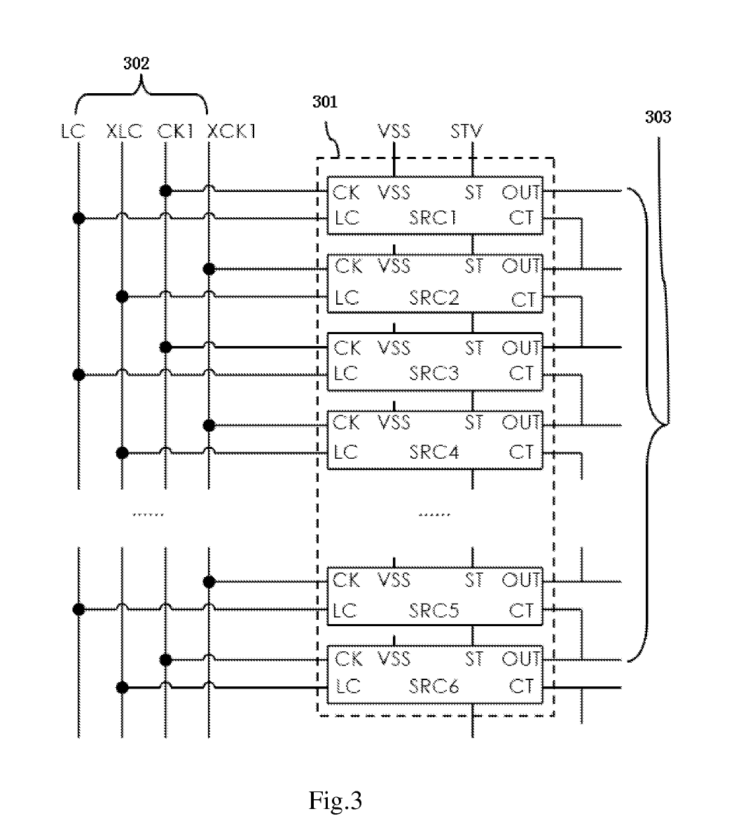

Referring to FIG. 3, FIG. 3 is a schematic diagram of the driving circuit 101 of the display panel according to the first embodiment of the present invention.

The signal input port 302 is operative to receive the first driving signal. The signal output port 303 is operative to output the second driving signal. The shift register combination 301 is connected to the signal input port 302 and the signal output port 303, and the shift register combination 301 is operative to produce the second driving signal in accordance with the first driving signal.

In the present embodiment, each shift register of the shift register combination 301 produces scanning signals by a first predetermined order, wherein the first predetermined order is the arrangement order of each shift register of the shift register combination 301 (the arrangement orders along the first direction 104).

For example, the first shift register SRC1, the second shift register SRC2, the third shift register SRC3 . . . and the 2N+1^{th} shift register SRC2N+1 produce the scanning signal of the pixel row successively.

In the present embodiment, the second driving signal comprises a first scanning signal and a second scanning signal.

The signal output port 303 comprises at least a first signal output end and at least a second signal output end. The first signal output end is operative to output the first scanning signal. The second signal output end is operative to output the second scanning signal.

The driving circuit 101 further comprises a power signal receiving end and a first start signal receiving end. The power signal receiving end is operative to receive a power signal. The first start signal receiving end is operative to receive a first start signal.

The shift register combination 301 comprises at least a first shift register SRC1 (Shift Register Circuit 1), at least a second shift register SRC2. For each shift register of the shift register combination 301, the power terminal VSS is operative to receive constant low-potential signals. A start signal receiving end ST is operative to receive start signals transmitted by a high-level shift register. The start signals transmitted by the high-level shift register are operative to trigger a low-level shift register (present-level shift register) to action/work. A first receiving end CK and a second receiving end LC are both operative to receive driving signals. An output end “Out” is operative to output the second driving signal. A third receiving end CT is operative to receive a pull-down signal transmitted by the lower-level shift register corresponding to the high-level shift register (present-level shift register).

The first shift register SRC1 is connected to the signal input port 302, the power signal receiving end, the first start signal receiving end, and the first signal output end. The first shift register SRC1 is operative to receive the first start signal, to produce the first scanning signal in accordance with the first driving signal at the first start signal triggering, and to produce a second start signal after producing the first scanning signal.

The second shift register SRC2 is connected to the signal input port 302, the power signal receiving end and the first shift register SRC1. The second shift register SRC2 is operative to receive the second start signal, to produce the second scanning signal in accordance with the first driving signal at the second start signal triggering, to transmit the second scanning signal to the first shift register SRC1, and to produce a third start signal after producing the second scanning signal.

In the present embodiment, the first driving signal comprises a first clock signal, a second clock signal, a third clock signal, and a fourth clock signal.

The signal input port 302 comprises a first signal input end LC, a second signal input end XLC, a third signal input end CK, and a fourth signal input end XCK.

The first signal input end LC is operative to receive the first clock signal. The second signal input end XLC is operative to receive the second clock signal. The third signal input end CK is operative to receive the third clock signal. The fourth signal input end XCK is operative to receive the fourth clock signal.

The first shift register SRC1 is connected to any two of the first signal output end, the second signal output end, the third signal output end, and the fourth signal output end. The first shift register SRC1 is operative to produce the first scanning signal in accordance with any two of the first clock signal, the second clock signal, the third clock signal and the fourth clock signal.

The second shift register SRC2 is connected to any two of the first signal output end, the second signal output end, the third signal output end, and the fourth signal output end. The second shift register SRC2 is operative to produce the second scanning signal in accordance with the first clock signal, the second clock signal, the third clock signal, and the fourth clock signal.

The display panel of the fourth embodiment of the present invention is similar to any one display panel of the first embodiment, the second embodiment, or the third embodiment, and the difference is as follows:

The shift register combination 301 further comprises at least a third shift register SRC3 and at least a fourth shift register SRC4. The signal output port 303 further comprises at least a third signal output end and at least a fourth signal output end.

The first signal input end LC is connected to the first shift register SRC1 and the third shift register SRC3. The first signal input end LC is further operative to provide the first clock signal to the first shift register SRC1 and the third shift register SRC3. The second signal input end XLC is connected to the second shift register SRC2 and the fourth shift register SRC4. The second signal input end XLC is further operative to provide the second clock signal to the second shift register SRC2 and the fourth shift register SRC4. The third signal input end CK is connected to the first shift register SRC1 and the third shift register SRC3. The third signal input end CK is further operative to provide the third clock signal to the first shift register SRC1 and the third shift register SRC3. The fourth signal input end XCK is connected to the second shift register SRC2 and the fourth shift register SRC4. The fourth signal input end XCK is further operative to provide the fourth clock signal to the second shift register SRC2 and the fourth shift register SRC4.

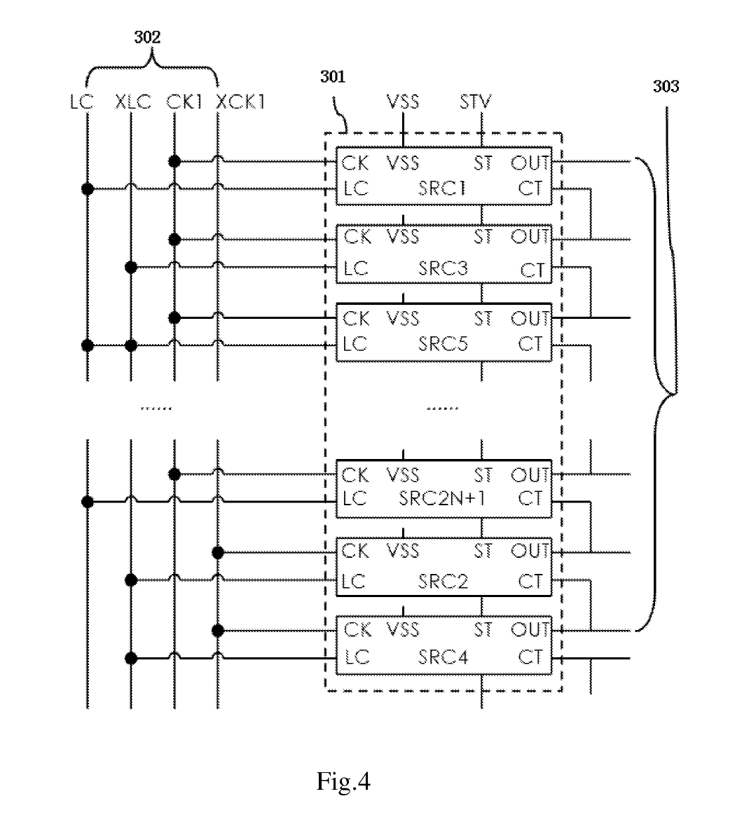

The display panel of the fifth embodiment of the present invention is similar to the display panel of the fourth embodiment as illustrated in FIG. 4, and the difference is as follows:

The first signal input end LC is connected to the first shift register SRC1 and the fourth shift register SRC4. The first signal input end LC is further operative to provide the first clock signal to the first shift register SRC1 and the fourth shift register SRC4. The second signal input end XLC is connected to the second shift register SRC2 and the third shift register SRC3. The second signal input end XLC is further operative to provide the second clock signal to the second shift register SRC2 and the third shift register SRC3. The third signal input end CK is connected to the first shift register SRC1 and the fourth shift register SRC4. The third signal input end CK is further operative to provide the third clock signal to the first shift register SRC1 and the fourth shift register SRC4. The fourth signal input end XCK is connected to the second shift register SRC2 and the third shift register SRC3. The fourth signal input end XCK is further operative to provide the fourth clock signal to the second shift register SRC2 and the third shift register SRC3.

In the present embodiment, each shift register of the shift register combination 301 produces scanning signals based on a second predetermined order. The second predetermined order is firstly producing scanning signals of odd number pixel rows successively by the odd number pixel rows corresponding to at least two of the shift registers, and then producing scanning signals of even number pixel rows successively by the even number pixel rows corresponding to at least two of the shift registers. For example, firstly the first shift register SRC1, the third shift register SRC3, the fifth shift register SRC5 . . . and the 2N+1^{th} shift register SRC2N+1 produce the scanning signal of the odd number pixel row successively, and then the second shift register SRC2 and the fourth shift register SRC4 produce the scanning signal of the even number pixel rows successively.

This allows the charging situation of pixel elements of different pixel rows to be equal and makes sure that the pre-charge has the same polarity, so as to avoid charging unevenly.

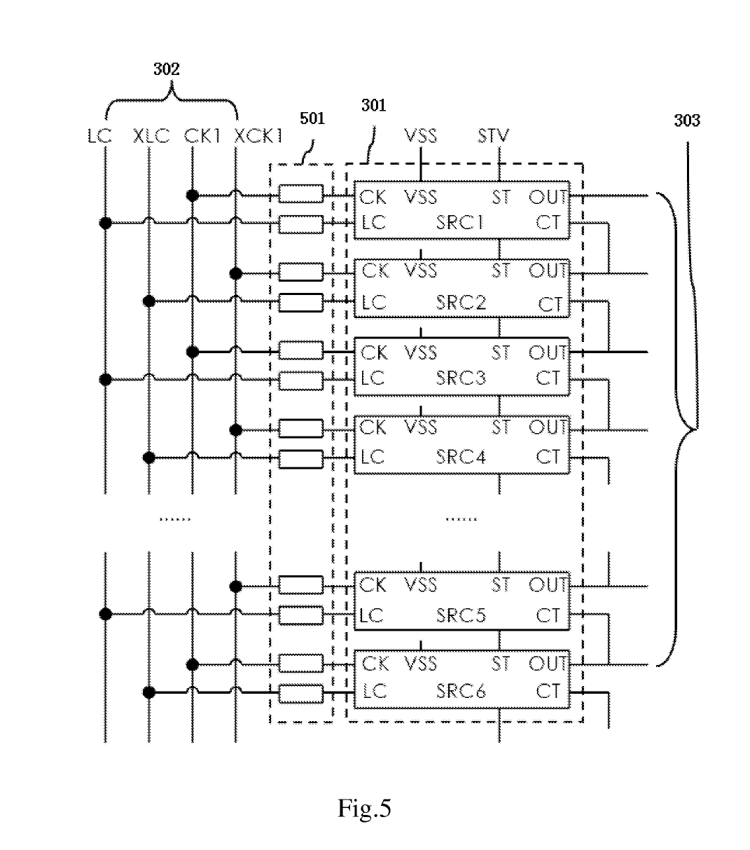

The display panel of the sixth embodiment of the present invention is similar to any one display panel of the first to the fifth embodiments, as illustrated in FIG. 5, and the difference is as follows:

The driving circuit 101 further comprises a first regulator combination 501.

The first regulator combination 501 is connected to the shift register combination 301 and the signal input port 302. The first regulator combination 501 is operative to regulate the first driving signal before the shift register combination 301 producing the second driving signal and operative to output the regulated first driving signal to the shift register combination 301.

The shift register combination 301 is further operative to produce the second driving signal in accordance with the regulated first driving signal.

In the present embodiment, the first regulator combination 501 comprises at least two first regulators, and the first regulator is a first current regulating resistance. The first current regulating resistance is connected to the shift register combination 301 (comprising the first shift register SRC1, the second shift register SRC2, the third shift register SRC3, and the fourth shift register SRC4) and the signal input port 302 (comprising the first signal input end LC, the second signal input end XLC, the third signal input end CK, the fourth signal input end XCK).

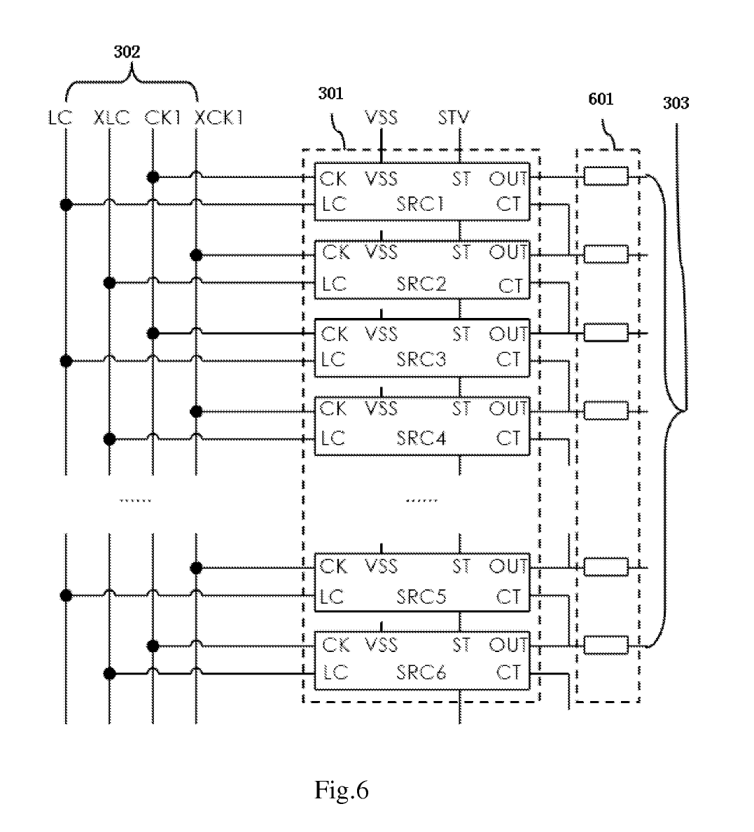

The display panel of the seventh embodiment of the present invention is similar to any one display panel of the first to the fifth embodiments, as illustrated in FIG. 6, and the difference is as follows:

The driving circuit 101 further comprises a second regulator combination 601.

The second regulator combination 601 is connected to the shift register combination 301 and the signal output port 303. The second regulator combination 601 is operative to regulate the second driving signal after the shift register combination 301 producing the second driving signal, and to output the regulated second driving signal to the pixel element array 102 through the scan line array G1, G2, G3, G4, G5 and G6.

In the present invention, the second regulator combination 601 comprises at least two second regulators, and the second regulator is a second current regulating resistance. The second current regulating resistance is connected to the shift register combination 301 (comprising the first shift register SRC1, the second shift register SRC2, the third shift register SRC3, and the fourth shift register SRC4) and the signal output port 303 (the first signal output end, the second signal output end, the third signal output end, the fourth signal output end).

In the above described technical solution of the sixth and seventh embodiments, through the first regulator regulating the first driving signal corresponding current and the second regulator regulating the second driving signal corresponding current, the control signal received by the TFT switches of each pixel element can be adjusted/regulated so as to control the charging process of the pixel element better. Therefore, appropriate charging restriction can be executed for the pixel elements which are in a better charging situation, and appropriate charging compensation can be executed for the pixel elements which are in a worse charging situation. This reduces abnormal screen displays and ensures the overall display quality of the screen.

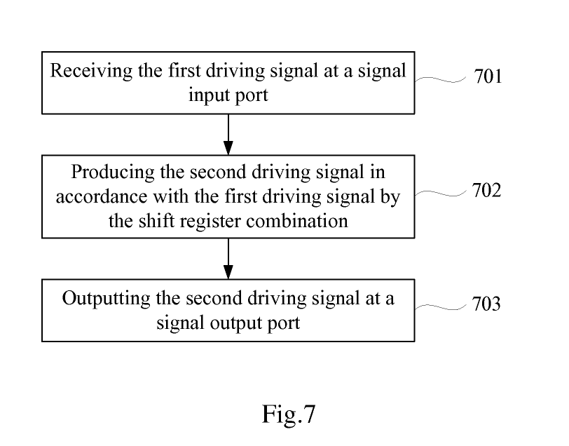

Referring to FIG. 7, FIG. 7 is a flowchart of a driving method of the display panel according to the first embodiment of the present invention.

A driving method of the display panel of the first embodiment of the present invention is adapted for the above described display panel, and this embodiment comprises the following steps of:
(A) Using the signal input port 302 to receive the first driving signal (step 701).
(B) Using the shift register combination 301 to produce the second driving signal in accordance with the first driving signal (step 702).
(C) Using the signal output port 303 to output the second driving signal (step 703).

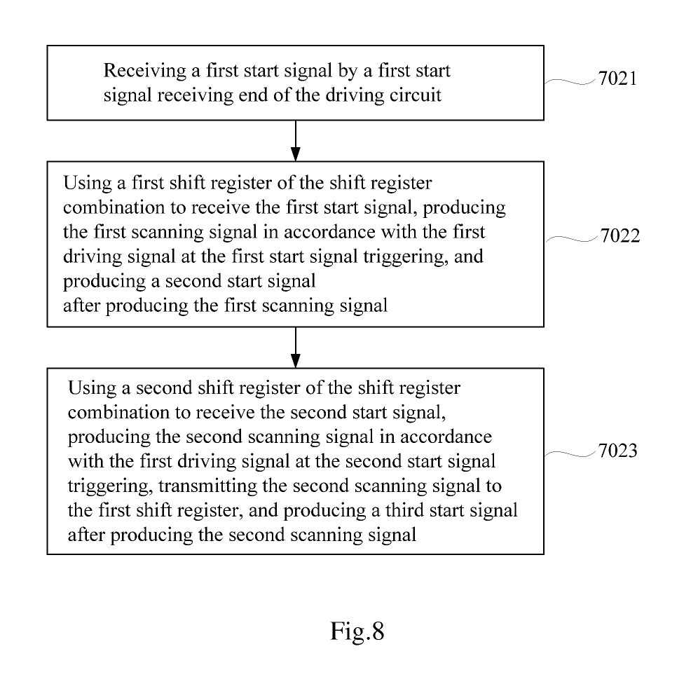

Referring to FIG. 8, FIG. 8 is a flowchart of the steps of producing a second driving signal in accordance with a first driving signal by a shift register combination 301.

In the present invention, the second driving signal comprises a first scanning signal and a second signal.

The step (B) (i.e. step 702) comprises the steps of:

(b1) Using a first start signal to receive end of the driving circuit 101 receives a first start signal (step 7021).

(b2) Using a first shift register SRC1 of the shift register combination 301 to receive the first start signal, produce the first scanning signal in accordance with the first driving signal at the first start signal triggering, and produce a second start signal after producing the first scanning signal (step 7022).

(b3) Using a second shift register SRC2 of the shift register combination 301 to receive the second start signal, produce the second scanning signal in accordance with the first driving signal at the second start signal triggering, transmit the second scanning signal to the first shift register, and produce a third start signal after producing the second scanning signal (step 7023).

In the present embodiment, the first driving signal comprises a first clock signal, a second clock signal, a third clock signal, and a fourth clock signal.

At the step b2 (i.e. step 7022), the step of producing the first scanning signal in accordance with the first driving signal comprises:

Using the first shift register SRC1 to produce the first scanning signal in accordance with any two of the first clock signal, the second clock signal, the third clock signal, and the fourth clock signal.

At the step b3 (i.e. step 7023), the step of producing the first scanning signal in accordance with the first driving signal comprises:

Using the second shift register SRC2 to produce the second scanning signal in accordance with any two of the first clock signal, the second clock signal, the third clock signal, and the fourth clock signal.

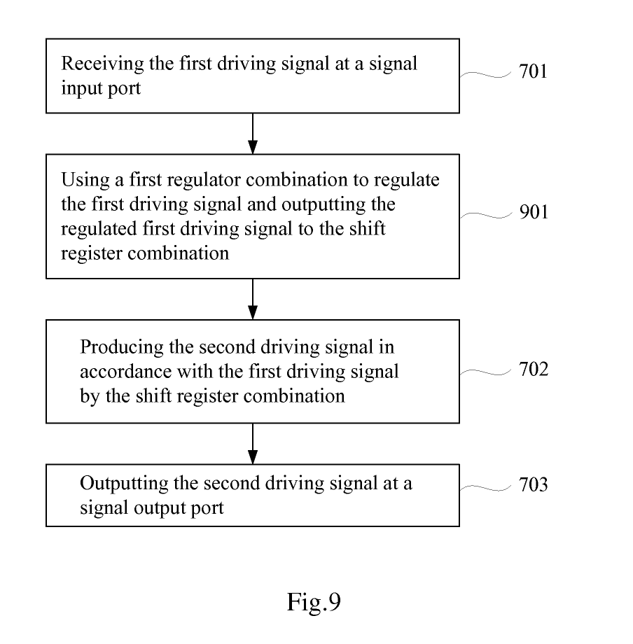

Referring to FIG. 9, FIG. 9 is a flowchart of a driving method of the display panel according to the second embodiment of the present invention.

The driving method of the display panel of the second embodiment of the present invention is similar to the first embodiment, and the difference is as follows:

After the step (A) and before the step (B), the method further comprises the following step of:

(D) Using a first regulator combination 501 of the driving circuit 101 to regulate the first driving signal before the shift register combination 301 produces the second driving signal, and to output the regulated first driving signal to the shift register combination 301 (step 901).

The step B (step 702) is as follows:

Using the shift register combination 301 to produce the second driving signal in accordance with the regulated first driving signal.

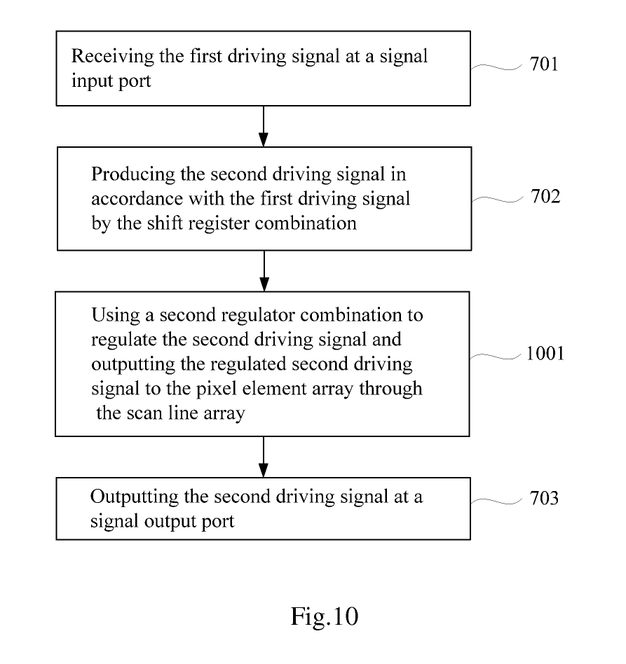

Referring to FIG. 10, FIG. 10 is a flowchart of a driving method of the display panel according to the third embodiment of the present invention.

The driving method of the display panel of the third embodiment of the present invention is similar to the first embodiment, and the difference is as follows:

After the step B (step 702) and before the step C (step 703), the method further comprises a step of:

(E) Using a second regulator combination 601 of the driving circuit 101 to regulate the second driving signal after the shift register combination 301 produces the second driving signal, and then to output the regulated second driving signal to the pixel element array 102 through the scan line array G1, G2, G3, G4, G5 and G6.

Through the first regulator regulating the first driving signal corresponding current and the second regulator regulating the second driving signal corresponding current, the control signal received by the TFT switches of each pixel element can be adjusted/regulated so as to control the charging process of the pixel element preferably. Therefore, appropriate charging restriction can be executed for the pixel elements which are in a better charging situation, and appropriate charging compensation can be executed for the pixel elements which are in a worse charging situation. This reduces abnormal screen displays and ensures the overall display quality of the screen.

There are one or more implementations represented or described for the present invention, but those who skilled in the art may provide some equivalent variations and modifications based on the understanding of the specification and the figures. The present invention comprises all the equivalent variations and modifications and is only constrained by the claims. Especially on the various functions of the above described components, the terms describing the components mean corresponding to any element (unless specially defined) with a specified function (for example with the equivalent function) of the implementation component, even if there is a different structure in comparison to the exemplary embodiments of the present specification. Furthermore, even though the specification discloses only an implementation of the specified feature, the specified feature can be combined with other characteristics if there are some advantages. In addition, the terms “including”, “having”, or other like terms used in detailed description or claims are similar to the meaning of the word “comprising.”

In summary, the present invention has been described with preferred embodiments thereof, but the above described preferred embodiments are not intended to limit the present invention. Those who are skilled in the art can make many changes and modifications to the described embodiment can be carried out without departing from the scope and the spirit of the invention that is intended to be limited only by the appended claims.

What is claimed is:

1. A display panel, wherein the display panel comprises:
a color filter substrate;
a liquid crystal layer; and
a thin film transistor array substrate, the thin film transistor array substrate comprising:
a pixel element array comprising at least two pixel rows and at least one pixel column combination, the pixel column combination comprising two pixel columns, the pixel row and the pixel column both being composed of pixel elements, wherein the pixel row comprises at least two of the pixel elements, and the pixel column comprises at least two of the pixel elements;
a scan line array comprising at least two scan line combinations, at least two of the scan line combinations arranged in an array along a first direction, the scan line combination comprising a first scan line and a second scan line, the first scan line and the second scan line both connected to the pixel element of the pixel row;
a data line array comprising at least two data lines, at least two of the data lines arranged in an array along a second direction, the data line connected to each of the pixel elements of the two pixel columns of the pixel column combination, wherein the first direction is perpendicular to the second direction; and
a driving circuit, the driving circuit connected to the scan line and the data line, the driving circuit operative to receive a first driving signal, operative to produce a second driving signal in accordance with the first driving signal, and operative to transmit the second driving signal to the pixel element array through the scan line array;
wherein the pixel elements connected to the first scan line and the pixel elements connected to the second scan line stagger in the pixel row;
the driving circuit comprising:
a signal input port operative to receive the first driving signal;
a signal output port operative to output the second driving signal; and
a shift register combination, the shift register combination connected to the signal input port and the signal output port, and the shift register combination operative to produce the second driving signal in accordance with the first driving signal;
the second driving signal comprising a first scanning signal and a second scanning signal;
the signal output port comprising:
at least a first signal output end operative to output the first scanning signal; and
at least a second signal output end operative to output the second scanning signal;
the driving circuit further comprising:
a power signal receiving end operative to receive a power signal; and
a first start signal receiving end operative to receive a first start signal;
the shift register combination comprising:
at least a first shift register, the first shift register connected to the signal input port, the power signal receiving end, the first start signal receiving end and the first signal output end; the first shift register operative to receive the first start signal, operative to produce the first scanning signal in accordance with the first driving signal at the first start signal triggering, and operative to produce a second start signal after producing the first scanning signal; and
at least a second shift register, wherein the second shift register connected to the signal input port, the power signal receiving end and the first shift register; the second shift register operative to receive the second start signal, operative to produce the second scanning signal in accordance with the first driving signal at the second start signal triggering, operative to transmit the second scanning signal to the first shift register, and operative to produce a third start signal after producing the second scanning signal;
wherein two of the neighboring pixel columns share the same data line; and, in objects connected to the pixel row, there is only one of the data lines.

2. The display panel according to claim 1, wherein the first driving signal comprises a first clock signal, a second clock signal, a third clock signal, and a fourth clock signal;
wherein the signal input port comprises:
a first signal input end operative to receive the first clock signal;
a second signal input end operative to receive the second clock signal;
a third signal input end operative to receive the third clock signal; and
a fourth signal input end operative to receive the fourth clock signal;
the first shift register connected to any two of the first signal output end, the second signal output end, the third signal output end, and the fourth signal output end, the first shift register operative to produce the first scanning signal in accordance with any two of the first clock signal, the second clock signal, the third clock signal, and the fourth clock signal; and
the second shift register connected to any two of the first signal output end, the second signal output end, the third signal output end, and the fourth signal output end, the second shift register operative to produce the second scanning signal in accordance with the first clock signal, the second clock signal, the third clock signal, and the fourth clock signal.

3. The display panel according to claim 1, wherein the driving circuit further comprises:
a first regulator combination connected to the shift register combination and the signal input port, the first regulator combination operative to regulate the first driving signal before the shift register combination producing the second driving signal, and operative to output the regulated first driving signal to the shift register combination;
the shift register combination operative to produce the second driving signal in accordance with the regulated first driving signal.

4. The display panel according to claim 1, wherein the driving circuit further comprises:
a second regulator combination connected to the shift register combination and the signal output port, the second regulator combination operative to regulate the second driving signal after the shift register combination producing the second driving signal, and operative to output the regulated second driving signal to the pixel element array through the scan line array.

5. A display panel, wherein the display panel comprises:
a color filter substrate;
a liquid crystal layer; and
a thin film transistor array substrate, the thin film transistor array substrate comprising:
a pixel element array comprising at least two pixel rows and at least one pixel column combination, the pixel column combination comprising two pixel columns, the pixel row and the pixel column being both composed of pixel elements, wherein the pixel row comprises at least two of the pixel elements, and the pixel column comprises at least two of the pixel elements;
a scan line array comprising at least two scan line combinations, at least two of the scan line combinations arranged in an array along a first direction, the scan line combination comprising a first scan line and a second scan line, the first scan line and the second scan line both connected to the pixel element of the pixel row;
a data line array comprising at least two data lines, at least two of the data lines arranged in an array along a second direction, the data line connected to each of the pixel elements of the two pixel columns of the pixel column combination, wherein the first direction is perpendicular to the second direction; and
a driving circuit the driving circuit connected to the scan line and the data line, the driving circuit operative to receive a first driving signal, operative to produce a second driving signal in accordance with the first driving signal, and operative to transmit the second driving signal to the pixel element array through the scan line array;
wherein the pixel elements connected to the first scan line and the pixel elements connected to the second scan line stagger in the pixel row.

6. The display panel according to claim 5, wherein two of the neighboring pixel columns share the same data line; and, in objects connected to the pixel row, there is only one of the data lines.

7. The display panel according to claim 5, wherein the driving circuit comprises:
a signal input port operative to receive the first driving signal;
a signal output port operative to output the second driving signal; and
a shift register combination, the shift register combination connected to the signal input port and the signal output port, and the shift register combination operative to produce the second driving signal in accordance with the first driving signal.

8. The display panel according to claim 7, wherein the second driving signal comprises a first scanning signal and a second scanning signal;
wherein the signal output port comprises:
at least a first signal output end operative to output the first scanning signal; and
at least a second signal output end operative to output the second scanning signal;
wherein the driving circuit further comprises:
a power signal receiving end operative to receive a power signal; and
a first start signal receiving end operative to receive a first start signal;
wherein the shift register combination comprises:
at least a first shift register, the first shift register connected to the signal input port, the power signal receiving end, the first start signal receiving end and the first signal output end; the first shift register operative to receive the first start signal, operative to produce the first scanning signal in accordance with the first driving signal at the first start signal triggering, and operative to produce a second start signal after producing the first scanning signal; and
at least a second shift register, the second shift register connected to the signal input port, the power signal receiving end, and the first shift register; the second shift register operative to receive the second start signal, operative to produce the second scanning signal in accordance with the first driving signal at the second start signal triggering, operative to transmit the second scanning signal to the first shift register, and operative to produce a third start signal after producing the second scanning signal.

9. The display panel according to claim 8, wherein the first driving signal comprises a first clock signal, a second clock signal, a third clock signal, and a fourth clock signal;
wherein the signal input port comprises:
a first signal input end operative to receive the first clock signal;
a second signal input end operative to receive the second clock signal;
a third signal input end operative to receive the third clock signal; and
a fourth signal input end operative to receive the fourth clock signal;
the first shift register connected to any two of the first signal output end, the second signal output end, the third signal output end, and the fourth signal output end, the first shift register operative to produce the first scanning signal in accordance with any two of the first clock signal, the second clock signal, the third clock signal, and the fourth clock signal; and
the second shift register connected to any two of the first signal output end, the second signal output end, the third signal output end, and the fourth signal output end, the second shift register operative to produce the second scanning signal in accordance with any two of the first clock signal, the second clock signal, the third clock signal, and the fourth clock signal.

10. The display panel according to claim 8, wherein each shift register of the shift register combination operates to produce scanning signals based on a second predetermined order;
wherein the second predetermined order is:
firstly producing scanning signals of odd number pixel rows successively by the odd number pixel rows corresponding to at least two of the shift registers, and then producing scanning signals of even number pixel rows successively by the even number pixel rows corresponding to at least two of the shift registers.

11. The display panel according to claim 7, wherein the driving circuit further comprises:
a first regulator combination connected to the shift register combination and the signal input port, the first regulator combination operative to regulate the first driving signal before the shift register combination producing the second driving signal, and operative to output the regulated first driving signal to the shift register combination;
the shift register combination further operative to produce the second driving signal in accordance with the regulated first driving signal.

12. The display panel according to claim 11, wherein the first regulator combination comprises at least two first regulators, the first regulator being a first current regulating resistance;
wherein the first current regulating resistance connects to the shift register combination and the signal input port.

13. The display panel according to claim 7, wherein the driving circuit further comprises:
a second regulator combination connected to the shift register combination and the signal output port, the second regulator combination operative to regulate the second driving signal after the shift register combination producing the second driving signal, and operative to output the regulated second driving signal to the pixel element array through the scan line array.

14. The display panel according to claim 13, wherein the second regulator combination comprises at least two second regulators, the second regulator being a second current regulating resistance;
wherein the second current regulating resistance connects to the shift register combination and the signal input port.

15. A driving method of a display panel according to claim 5, wherein the driving method comprises steps of:
(A) receiving the first driving signal at a signal input port;
(B) producing the second driving signal in accordance with the first driving signal by the shift register combination; and
(C) outputting the second driving signal at a signal output port.

16. The driving method according to claim 15, wherein the second driving signal comprises a first scanning signal and a second scanning signal;
the step (B) comprising steps of:
(b1) receiving a first start signal by a first start signal receiving end of the driving circuit;
(b2) using a first shift register of the shift register combination to receive the first start signal, producing the first scanning signal in accordance with the first driving signal at the first start signal triggering, and producing a second start signal after producing the first scanning signal; and
(b3) using a second shift register of the shift register combination to receive the second start signal, producing the second scanning signal in accordance with the first driving signal at the second start signal triggering, transmitting the second scanning signal to the first shift register, and producing a third start signal after producing the second scanning signal.

17. The driving method according to claim 16, wherein the first driving signal comprises a first clock signal, a second clock signal, a third clock signal, and a fourth clock signal;
the method further comprising steps of:
receiving the first clock signal by a first signal input end of the signal input port;
receiving the second clock signal by a second signal input end of the signal input port;
receiving the third clock signal by a third signal input end of the signal input port;
receiving the fourth clock signal by a fourth signal input end of the signal input port;
producing the first scanning signal by the first shift register in accordance with any two of the first clock signal, the second clock signal, the third clock signal, and the fourth clock signal, wherein the first shift register is connected to any two of the first signal output end, the second signal output end, the third signal output end, and the fourth signal output end; and
producing the second scanning signal by the second shift register in accordance with any two of the first clock signal, the second clock signal, the third clock signal and the fourth clock signal, wherein the second shift register is connected to any two of the first signal output end, the second signal output end, the third signal output end, and the fourth signal output end.

18. The driving method according to claim 16, wherein the method further comprises a step of:
producing scanning signal based on a second predetermined order by each shift register of the shift register combination;
wherein the second predetermined order is:
firstly producing scanning signals of odd number pixel rows successively by the odd number pixel rows corresponding to at least two of the shift registers, and then producing scanning signals of even number pixel rows successively by the even number pixel rows corresponding to at least two of the shift registers.

19. The driving method according to claim 15, wherein after the step (A) and before the step (B), the method further comprises a step of:
(D) using a first regulator combination of the driving circuit to regulate the first driving signal before the shift register combination produces the second driving signal, and then outputting the regulated first driving signal to the shift register combination;
wherein the step (B) is:
producing the second driving signal in accordance with the regulated first driving signal by the shift register combination.

20. The driving method according to claim 15, wherein after the step (B) and before the step (C), the method further comprises a step of:
(E) using a second regulator combination of the driving circuit to regulate the second driving signal after the shift register combination produces the second driving signal, and then outputting the regulated second driving signal to the pixel element array through the scan line array.
